(19) United States
(12) Patent Application Publication
(10) Pub. No.: US 2026/0045756 A1
(43) Pub. Date: Feb. 12, 2026

(54) Fiber laser pumping of bismuth-doped O-band amplifier

(71) Applicant: OFS Fitel, LLC, Norcross, GA (US)

(72) Inventors: David J DiGiovanni, Mountain Lakes, NJ (US); Vitaly Mikhailov, Oxford, NJ (US)

(73) Assignee: OFS Fitel, LLC, Norcross, GA (US)

(21) Appl. No.: 19/100,597

(22) PCT Filed: May 25, 2023
(86) PCT No.: PCT/US2023/023480

§ 371 Date: Feb. 3, 2025

Related U.S. Application Data
(60) Provisional application No. 63/394,474, filed on Aug. 2, 2022.

(51) Int. Cl. H01S 3/094; H01S 3/067; H01S 3/0941; H01S 3/16

(52) U.S. Cl. CPC H01S 3/094053; H01S 3/06716; H01S 3/0675; H01S 3/094003; H01S 3/094069; H01S 3/0941; H01S 3/1601

(57) ABSTRACT

A Bismuth-doped fiber-optic amplifier (BDFA) system in which a Bismuth-doped optical fiber (BDF) is pumped by a fiber-laser pump (rather than by a semiconductor pump). Because higher-power fiber-laser pumps permit over-pumping of the BDF, there are benefits to the fiber-laser-pumped BDFA that cannot be realized with inherently lower-power semiconductor pumps.

### CROSS REFERENCE TO RELATED APPLICATIONS

This application claims the benefit of U.S. provisional patent application Ser. No. 63/394,474, filed 2022 Aug. 2, having the title “Fiber Laser Pumping of Bismuth-Doped O-Band Amplifier,” by DiGiovanni, et al., which is incorporated herein by reference in its entirety.

### BACKGROUND

### Field of the Disclosure

The present disclosure relates generally to optics and, more particularly, to optical amplifiers.

### Description of Related Art

Bismuth-doped fibers (BDFs) for BDF amplifiers (BDFAs)have been used in a wavelength range of 1265 nm to 1345 nm. Conventionally, within this wavelength range, the BDFs are pumped usingquantum dot (QD) semiconductor laserscoupled to single-mode fiber (SMF), as shown, for example, in U.S. patent application Ser. No. 17/724,362, filed on 2021 Mar. 8, and PCT Application Number PCT/US19/51024, filed on 2019 Sep. 13. However, there are drawbacks to using SMF-QD semiconductor pumps.

### SUMMARY

The present disclosure teaches a Bismuth-doped fiber-optic amplifier (BDFA) system in which a Bismuth-doped optical fiber (BDF) is pumped by a fiber-laser pump (rather than by a semiconductor pump). Because higher-power fiber-laser pumps permit over-pumping of the BDF, there are benefits to the fiber-laser-pumped BDFA that cannot be realized with inherently lower-power semiconductor pumps.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram showing one embodiment of a forward-pumped (or co-pumped) Bismuth-doped fiber-optic amplifier (BDFA) for an example test configuration.

FIG. 1B is a block diagram showing one embodiment of a forward-pumped (or co-pumped) BDFA in an example telecom environment.

FIG. 2 is a block diagram showing one embodiment of a backward-pumped (or counter-pumped) BDFA.

FIG. 3 is a graph showing optical pump power (in Watts (W)) plotted in relation to electrical power (in W) for one embodiment of a BDFA, with a graph inset showing a temperature-dependent wavelength shift for the cladding-pumped fiber-laser pump.

FIG. 4 is a graph showing gain and noise figure (NF) plotted in relation to wavelength for the embodiment of the forward-pumped BDFA shown in FIG. 1A, with a graph inset showing BDFA output spectra in relation to wavelength for the embodiment of the BDFA of FIG. 1A.

FIG. 5 is a graph showing bit-error rate (BER) plotted in relation to channel power for the embodiment of the forward-pumped BDFA in FIG. 1A.

FIG. 6 is a graph showing gain and NF plotted in relation to wavelength for the embodiment of the backward-pumped BDFA of FIG. 2.

### DETAILED DESCRIPTION OF THE EMBODIMENTS

Bismuth-doped fibers (BDFs) for BDF amplifiers (BDFAs) in a wavelength range of 1265 nm to 1345 nm are conventionally pumped using semiconductor quantum dot (QD) laserscoupled to single-mode fiber (SMF). To properly pump the BDFs so that the signal operating wavelength range is ˜1265 nm to ˜1345 nm, the SMF-QD semiconductor pumps operate in a pump wavelength range of ˜1190 nm to ˜1200 nm. Moreover, approximately twenty percent (˜20%) of the signal bandwidth overlaps with the OH absorption peak, which reduces BDFA gain and increases the noise figure (NF). Because the pump wavelengths (1190 nm-1200 nm) fall between Indium-Gallium-Arsenide (InGaAs) and Indium-Phosphorous (InP) semiconductor technologies, the pumps can only be realized currently by SMF-QD semiconductor laser pumps. Consequently, the BDFA pumps are less power efficient, more expensive, and limited in supply. In other words, the use of SMF-QD semiconductor pumps results in lower power conversion efficiency in this operating wavelength range due to the inherently lower power associated with semiconductor pumps.

To address the drawbacks associated with SMF-QD semiconductor pumps, this disclosure teaches BDFA systems in which BDFs are pumped by a fiber-laser pump (rather than by a semiconductor pump). Because higher-power fiber-laser pumps permit over-pumping of the BDF, there are benefits to the fiber-laser-pumped BDFA that cannot be realized with inherently lower-power semiconductor pumps. One preferred embodiment shows a BDFA with a BDF that is pumped with a conversion stage having a single commercial-off-the shelf (COTS) low-brightness uncooled multimode (MM) laser diode via a double-clad ytterbium (Yb) doped fiber (YDF). That preferred embodiment has a gain of over twenty decibels (>20 dB) (specifically, a gain of approximately 29.3 decibels (˜29.3 dB)), in a wavelength range between ˜1255 nm and ˜1355 nm (which is a bandwidth of approximately 17.6 Terahertz (˜17.6 THz)). For that preferred embodiment, the NF is below ˜5.2 dB (specifically, ˜4.6 dB at a center wavelength (λ) of ˜1300 nm and an input power (Pᵢₙ) of approximately ˜20 decibel-milliwatts (˜20 dBm)) and the BDFA has an electrical consumption from approximately 8.1 Watts (˜8.1 W) to ˜9.6 W or ˜9.8 W over a temperature range from approximately twenty degrees Celsius (˜20° C.) to ˜70° C.

Having provided a broad technical solution to a technical problem, as well as one preferred embodiment of the technical solution, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

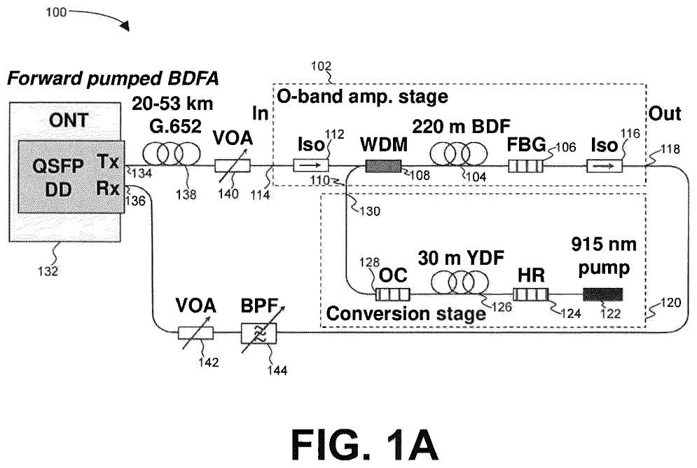

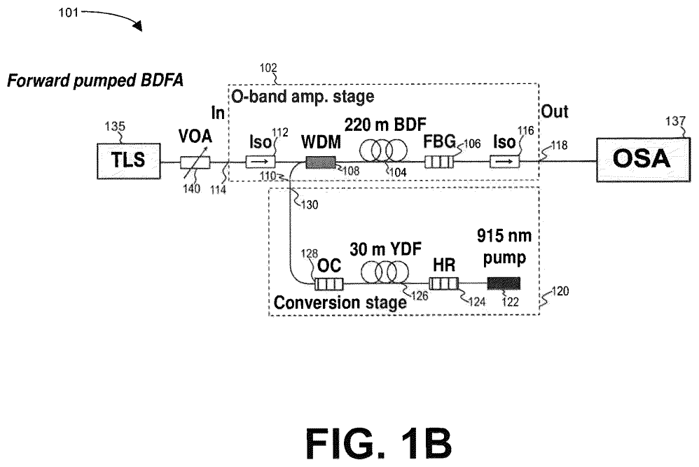

FIG. 1A is a block diagram showing one embodiment of a forward-pumped (or co-pumped) BDFA system 100. As shown in FIG. 1A, the embodiment of the BDFA system 100 comprises an amplification stage 102, which, for illustrative purposes, is shown as an Original-Band (O-Band) amplification stage that operates in a wavelength range from ˜1260 nm to ˜1360 nm. Those having skill in the art will appreciate that, although the O-Band is shown as an example, the BDFA system 100 and the amplification stage 102 can also be operated in an Extended-Band (E-Band, ranging from ˜1360 nm to 18 1460 nm), a Short-Wavelength-Band (S-Band, ranging from ˜1460 nm to ˜1530 nm), or any other operating wavelength band to which a BDFA can be configured to operate.

Continuing, the amplification stage 102 comprises a bismuth-doped fiber (BDF) 104. For purposes of illustration, and to show experimental results, the BDF 104 is shown as a 220-meter (220 m) BDF with a Bismuth (Bi) doped phospho-silicate glass BDF core, which was prepared by modified chemical vapor deposition (MCVD). The BDF core diameter is approximately eight micrometers (˜8 μm) and the BDF cladding diameter is ˜125 μm. This embodiment of the BDF 104 has a numerical aperture (NA) of approximately 0.13 (˜0.13) and a cutoff wavelength (λ) of ˜1180 nm, which permits single-mode (SM) operation in the O-Band. An actual measurement of the fiber loss at a pump wavelength of ˜1150 nm was ˜0.3 dB/m, when measured by a cut-back method. It should be appreciated by those having skill in the art that the length, core diameter, cladding diameter, and other properties of the BDF 104 can be changed to accommodate various system requirements.

Next, the amplification stage 102 further comprises an output fiber Bragg grating (FBG) 106 that is optically coupled (e.g., by fusion splicing or other known optically coupling process) to the BDF 104 at the BDF output and a wavelength division multiplexer (WDM) 108 that has its output (or WDM output) optically coupled to the BDF 104 at the BDF input. One embodiment of the output FBG 106 has a reflectivity of ˜99% to prevent pump leakage and improve amplifier gain by ˜1 dB and improve noise figure (NF) by ˜0.3 dB. An example embodiment of the WDM 108 is a thin-film-filter-based WDM, which is known in the art. In the embodiment of FIG. 1A, the input to the WDM 108 (or WDM input) is the pump input 110 to the amplification stage 102.

The amplification stage 102 further comprises an input optical isolator 112 that is also optically coupled to the WDM input and an output optical isolator 116 that is optically coupled to the output FBG 106. For the embodiment of FIG. 1A, the input to the input optical isolator 112 is also the amplification stage signal input 114, while the output of the output optical isolator 116 is the amplification stage output 118.

In addition to the amplification stage 102, the BDFA system 100 comprises a conversion stage 120, which pumps the amplification stage 102. The conversion stage 120 comprises a pump laser diode (LD) 122, which is shown for illustrative purposes as a ten watt (10 W) rated multimode (MM) uncooled pump LD for providing pump light at an operating center λ of ˜915 nm. The specific embodiment of the pump LD 122 has a light-output-to-current-input slope (LI-slope) efficiency of ˜0.88 to ˜0.82 and operates at a threshold current of between approximately 510 milliamps (˜510 mA) and ˜630 mA at temperatures ranging from ˜20° C. to ˜70° C.

The conversion stage 120 further comprises a high-reflection (HR) FBG 124 that is optically coupled to the pump LD 122. For some embodiments, the HR FBG 124 has ˜99% reflectivity. Optically coupled to the HR FBG 124 is a gain-doped optical fiber 126, which is shown in FIG. 1A as a 30 m double-clad Ytterbium-doped optical fiber (YDF) with a ˜6 μm core diameter and a ˜125 μm cladding diameter. An output of the gain-doped fiber 126 is optically coupled an optical coupler (OC) FBG 128. In the conversion stage 120 of FIG. 1A, the OC FBG 128 has ˜75% reflectivity. For some embodiments, the HR FBG 124 is written with 1 nm-3 dB-bandwidth, ˜99.9% reflectivity, while the OC FBG 128 is written with 1 nm-3 dB-bandwidth, ˜75% reflectivity, thereby permitting lasing of the gain-doped fiber 126. Insofar as the OC FBG 128 resides at the conversion stage output 130, the OC FBG 128 is optically coupled to the input of the WDM 108, which is located at the amplification stage input 110.

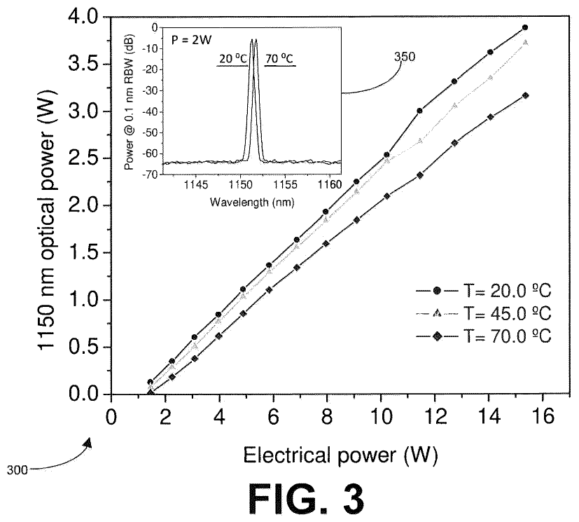

The conversion stage 120 output optical power (in Watts (W)) at λ of ˜1150 nm in relation to electrical power (in W) for various temperatures (e.g., ˜20.0° C., ˜45.0° C., and ˜70.0° C.) are shown in the graph 300 of FIG. 3. The graph 300 shows an overall electrical-to-optical power conversion efficiency in the range of ˜0.25 to ˜0.20 for two Watt (2 W) pump power at λ of ˜1150 nm. It should be noted that the conversion stage 120 operates relatively kink-free up to ˜2.25 W of output power and any kink is likely caused by pump laser power jump. Thus, to generate 2 W of 1150 nm pump power, the current and voltage of the pump LD 122 is ˜4.6 amps (A) and ˜1.77 volts (V) respectively at ˜20° C., while the current and voltage of the pump LD 122 is ˜5.3A and ˜1.84V respectively at ˜70° C. The inset 350 of FIG. 3 shows conversion stage 120 spectra at the 2 W output power for both ˜20° C. and ˜70° C. Specifically, the inset 350 spectra shows amplified spontaneous emissions (ASE) levels at ˜57 dB and ˜0.5 nm temperature-induced wavelength shift from ˜20° C. to ˜70° C.

Ultimately, the amplification stage 102 is pumped by a fiber-laser-based conversion stage 120, thereby permitting over-pumping of the BDF 104, which is not practically feasible with conventional SMF-QD semiconductor pumps. Furthermore, the electrical power consumption of the disclosed BDFA system 100 is similar to conventionally pumped BDFAs operating over the same part of the O-Band at ˜20° C. At ˜45° C., the electrical power consumption of the disclosed BDFA system 100 is 1.7 times lower than conventionally pumped BDFAs. At ˜70° C., the electrical power consumption of the disclosed BDFA system 100 is more-than 3.5 times lower than conventionally pumped BDFAs.

To further clarify what is meant by over-pumping in this disclosure, some embodiments expressly define over-pumping to be when the BDF 104 is pumped with more pump power than is practical with semiconductor pumps. Those having skill in the art will understand the threshold that, if exceeded, would become impractical to add more pump power with semiconductor pumps, so that threshold is not recited numerically for this particular embodiment. By way of example, if ˜500 mW is available from a single semiconductor laser operating at a particular wavelength (λ1) to produce certain gain (G), then over-pumping is the pump power above at pump wavelength (λ2) that is required to exceed that gain (G). Note λ1 may be equal to or different from λ2. In other words, if a BDF of certain length produces ˜20 dB gain when pumped by a ˜1195 nm, ˜500 mW semiconductor pump, then everything above that level at the same pump wavelength (˜1195 nm) is the over-pumping (or excess pump). However, if ˜750 mW at ˜1150 nm of pump power is required to produce the same ˜20 dB gain, then everything above ˜750 mW is over-pumping (or excess pump). It should be noted that, for the same BDF (meaning, a BDF with the same Bi concentration, process parameters, etc.), the optimal fiber length may differ for differing pump wavelengths (λ2). For example, an approximately 170 meter (˜170 m) BDFmay require ˜500 mW of pump power at ˜1195 nm to produce ˜20 dB gain (meaning, the threshold for over-pumping would be ˜500 mW for that particular fiber), while ˜145 m BDF may require ˜750 mW of pump power at ˜1150 nm to produce that same ˜20 dB gain (meaning, the threshold for over-pumping would then be ˜750 mW).

For other embodiments, for example, where it is impractical to provide optimal pump power for every section of a BDF (e.g., requires too many pump stages along the gain fiber (BDF)), over-pumping would be expressly defined as providing sufficient power to automatically distribute pump power along every section of the BDF with some pump power being lost. Multimode (MM) pump diodes, which can produce several watts of power, are used for this embodiment, thereby permitting pump power of several watts, or over 10 W, or even over 100 W.

In yet other embodiments, over-pumping is expressly defined as a ratio of a desired threshold pump power to launched pump power (i.e., threshold/launched), such that every section of a gain fiber (e.g., every section of the BDF) is pumped higher than the desired threshold. For example, when a desired threshold power is ˜150 mW, with ˜1 W of launched pump power required for every section of the BDF to be pumped to more than ˜150 mW, the over-pumping level would be ˜15% (i.e., 150 mW/1 W=15%). In another example, if launched pump power of ˜2 W is required for every section of the BDF to be pumped beyond a threshold power of ˜150 mW, then the over-pumping level calculates to ˜150 mW/˜2 W=˜7.5%. Other calculations include: ˜2 W launched power for ˜0.2 W threshold power requires an over-pumping level of ˜10% (i.e., ˜0.2 W/˜2.0 W=˜10%); ˜1.0 W launched power for ˜0.15 W threshold power requires over-pumping of ˜15%; and so on and so on. For embodiments that expressly define over-pumping in terms of a threshold-power-to-launched-power ratio, a BDF that is pumped at a ˜10% threshold-to-launched ratio is considered to be over-pumped.

Ultimately, over-pumping under each of these express definitions is a pump power level that is greater than what can be practically implemented with semiconductor pumps, as understood by those having skill in the art.

The BDFA system 100 further comprises a signal transmitter 134 that is optically coupled to the amplification stage input 114 through a transmission fiber 138 and a variable optical attenuator (VOA) 140. In some embodiments, the transmission fiber 138 is a single-mode fiber (SMF) and, in the embodiment of FIG. 1A, the transmission fiber 138 is shown as a 20 km- to 53 km-length fiber that complies with Recommendation G.652: Characteristics of a single-mode optical fibre and cable, by the Telecommunication Standardization Sector of the International Telecommunications Union (ITU-T G.652), which is an industry standard that is familiar to those having ordinary skill in the art.

A signal receiver 136 is optically coupled to the amplification stage output 118 via a band-pass filter (BPF) 144 and another VOA 142. For some embodiments that demonstrate the suitability of the BDFA system 100 for near-real-time network data transmission using 400 Gigabits-per-second (400 Gb/s) with a 10-kilometer (10 km) nominal distance, an optical network tester(ONT) 132 comprising both the signal transmitter 134 and the signal receiver 136 were used. The ONT 132 generated 16×25 Gb/s, 2³¹-1 pseudo-random binary sequence (PRBS) data lanes. Inside the ONT 132, the lanes were converted to 4×50Gbaud/s pulse-amplitude-modulated (PAM) signal and encoded onto four (4) coarse wavelength division multiplexed (CWDM) channels at ˜1272 nm, ˜1292 nm, ˜1310 nm, and ˜1330 nm using external modulators. The baud rate was selected for its high sensitivity to noise. The signal receiver 136 in this embodiment was a quad small form-factor pluggable (SMFP) double-density (DD) receiver, where the wavelength-division-multiplexed (WDM) signals were separated by optical filters with 38 nm3dBbandwidth and converted back to electrical on-off-keying (OOK) signals.

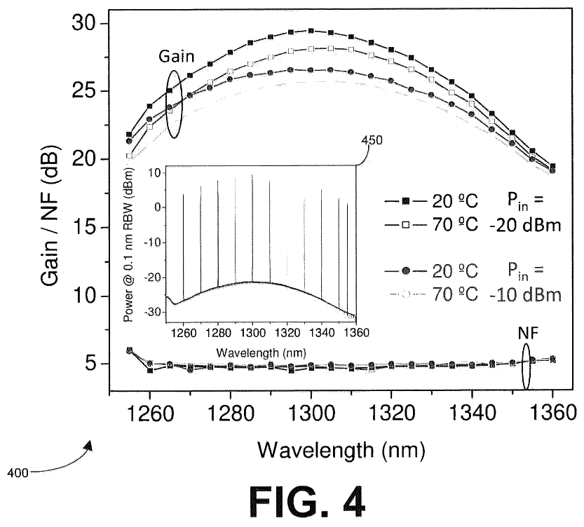

It should be appreciated that, for other embodiments, the signal transmitter 134 comprises a tunable laser source (TLS) that is optically coupled to the amplification stage signal input 114, while the signal receiver 136 comprises an optical spectrum analyzer (OSA) that is optically coupled to the amplification stage output 118. It should be appreciated that embodiments that use TLS and OSA as the signal transmitter 134 and the signal receiver 136 facilitate the measurement of gain and NF. By way of example, the plot 400 in FIG. 4 shows the measured gain and NF for the specific configuration shown in FIG. 1A when the input power at the BDFA is set to ˜20 dBm and ˜10 dBm. The inset 450 shows a set of BDFA output spectra for ˜20 dBm input power (with 0.1 nm resolution bandwidth (RBW)). The inset 450 shows a gain peak of 29.3 dB at ˜1300 nm with a corresponding NF of ˜4.6 dB. Over the entire λ range, the NF was below ˜5.2 dB, except at ˜1255 nm, where the measured NF fell to 6 dB due to a sharp rise in WDM loss. As shown in FIG. 4, at ˜20 dB input signal power, the BDFA demonstrates >20 dB gain for λ between ˜1255 nm and ˜1355 nm (which is 17.6 THz bandwidth). At ˜10 dB input signal power, the gain was 2.7 dB lower (compared to the gain for the ˜20 dBm input signal) and the NF was 0.2 dB higher (also compared to the ˜20 dBm input signal). The measured data also showed a temperature dependence with the gain peak shifting to ˜1305 nm at ˜70° C. (as compared to ˜20° C.), the gain being reduced by 1.1 dB maximum, and the NF increasing by 0.3 dB maximum across the wavelength range.

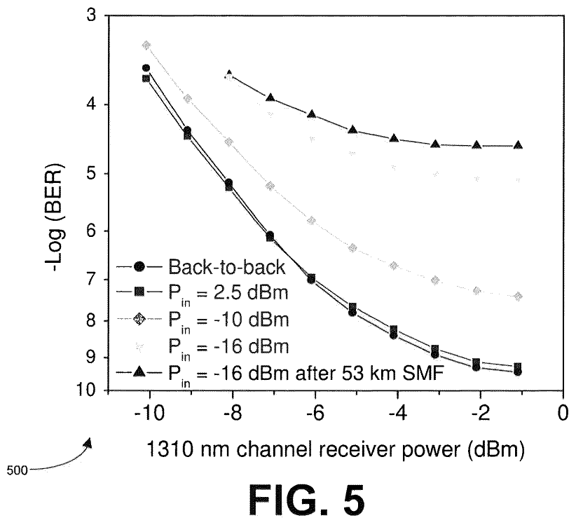

Data on conversion-stage noise sensitivity were also gathered for the forward-pumping BDFA system 100. The data, in the form of waterfall curves, are shown in the graph 500 of FIG. 5. The forward-pumping BDFA system 100 may be more susceptible to noise than the backward-pumping BDFA system 200. This is because the pump and the signal are propagated in the same direction for the forward-pumping BDFA system 100. The impact of amplified spontaneous emissions (ASE) was minimized by placing an external BPF 144 with 1 nm 3 dB bandwidth in the signal-transmission pathway in front of the signal receiver 136 (specifically, the QSFP-DD receiver). Although all four (4) channels were amplified, only the bit error rate (BER) of the ˜1310 nm wavelength channel was measured because ˜1310 nm was the desired signal wavelength for O-Band communication. The total power was ˜6 dB higher than the single-channel power. The input signal power (at the input to the BDFA) for λ of ˜1310 nm was set to ˜2.5 dBm to further reduce ASE. As shown in FIG. 5, the amplified transmission (namely, Pᵢₙ of 2.5 dBm, ˜10 dBM, ˜16 dBm, and ˜16 dBm after 53 km of SMF) and the unamplified back-to-back transmission, when compared, showed a small difference down to 5×10⁻¹⁰, which indicated that there is no significant conversion-stage noise associated with the forward pumping scheme. The smooth waterfall curves also indicate negligible conversion-stage noise.

When the BPF 144 is replaced with 20 km of G.652 fiber, the average BER was 4.5×10⁻⁶ for all four (4) CWDM channels over eight (8) hours of operation at 6 dBm receiver signal power and 0 dBm total input power to the BDFA.

At bottom, experimental results showed some embodiments of the BDFA system 100 operating over the standardized part of the O-Band with a gain >20 dB over a λ range of ˜1255 to ˜1355(with a −20 dBm input signal power) and typical noise figure (NF) that is below 5.2 dB, pumped by a single COTS high-brightness uncooled MM laser diode via a YDF-based conversion stage. The gain and NF of the BDFA were evaluated using an amplified spontaneous emission (ASE) spectral interpolation method, which is known in the art. The specific examples demonstrate that the embodiments of the BDFA system 100 operate over a temperature range of ˜20° C. to ˜70° C. with an overall power consumption that is similar to or better than prior-art single-mode (SM) diode-pumped amplifiers operating over the same part of the O-Band. The embodiment of the BDFA system 100 is suitable for data transmission by amplifying 50 GBaud/s PAM-4 signals from a pluggable module over a ˜17.6 THz bandwidth range. In the embodiment shown in FIG. 1A, the BDFA had a polarization-dependent loss (PDL) that was less than 0.15 dB and differential group delay (DGD) less than 0.3 picoseconds (ps).

FIG. 1B is a block diagram showing one embodiment of a forward-pumped (or co-pumped) BDFA system 101 in a telecom environment. As shown in FIG. 1B (and similar to FIG. 1A), the embodiment of the BDFA system 101 comprises an amplification stage 102, which, for illustrative purposes, is shown as an O-Band amplification stage that operates in a wavelength range from ˜1260 nm to ˜1360 nm. Those having skill in the art will appreciate that, although the O-Band is shown as an example, the BDFA system 101 and the amplification stage 102 can also be operated in an E-Band, S-Band, or any other operating wavelength band to which a BDFA can be configured to operate.

The amplification stage 102 comprises a BDF 104. Once again, for purposes of illustration, the BDF 104 is shown as a 220 m BDF with a Bismuth (Bi) doped phospho-silicate glass BDF core. The amplification stage 102 further comprises an output FBG 106 that is optically coupled (e.g., by fusion splicing or other known optically coupling process) to the BDF 104 at the BDF output and a WDM 108 that has its WDM output optically coupled to the BDF 104 at the BDF input. In the embodiment of FIG. 1B, the input to the WDM 108 (or WDM input) is the pump input 110 to the amplification stage 102.

The amplification stage 102 further comprises an input optical isolator 112 that is also optically coupled to the WDM input and an output optical isolator 116 that is optically coupled to the output FBG 106. For the embodiment of FIG. 1B, the input to the input optical isolator 112 is also the amplification stage signal input 114, while the output of the output optical isolator 116 is the amplification stage output 118.

In addition to the amplification stage 102, the BDFA system 101 comprises a conversion stage 120, which pumps the amplification stage 102. The conversion stage 120 comprises a pump LD 122, which is shown for illustrative purposes as a ten watt (10 W) rated multimode (MM) uncooled pump LD for providing pump light at an operating center, of ˜915 nm. The conversion stage 120 further comprises a HR FBG 124 that is optically coupled to the pump LD 122. Optically coupled to the HR FBG 124 is a gain-doped optical fiber 126, which is shown in FIG. 1B as a 30 m double-clad YDF. An output of the gain-doped fiber 126 is optically coupled an OC FBG 128. Insofar as the OC FBG 128 resides at the conversion stage output 130, the OC FBG 128 is optically coupled to the input of the WDM 108, which is located at the amplification stage input 110.

Ultimately, the amplification stage 102 is pumped by a fiber-laser-based conversion stage 120, thereby permitting over-pumping of the BDF 104, which is not practically feasible with conventional SMF-QD semiconductor pumps. Furthermore, the electrical power consumption of the disclosed BDFA system 101 is similar to conventionally pumped BDFAs operating over the same part of the O-Band at ˜20° C. At ˜45° C., the electrical power consumption of the disclosed BDFA system 101 is 1.7 times lower than conventionally pumped BDFAs. At ˜70° C., the electrical power consumption of the disclosed BDFA system 101 is more-than 3.5 times lower than conventionally pumped BDFAs.

The forward-pumped BDFA system 101 further comprises a signal transmitter 135, which is shown in FIG. 1B as a tunable laser source (TLS), as well as a signal receiver 137, which is shown as an optical spectrum analyzer (OSA) 137. The signal transmitter 135 is optically coupled to the amplification stage signal input 114 via a VOA 140, while the signal receiver 137 is optically coupled to the amplification stage output 118 (at the output optical isolator 116).

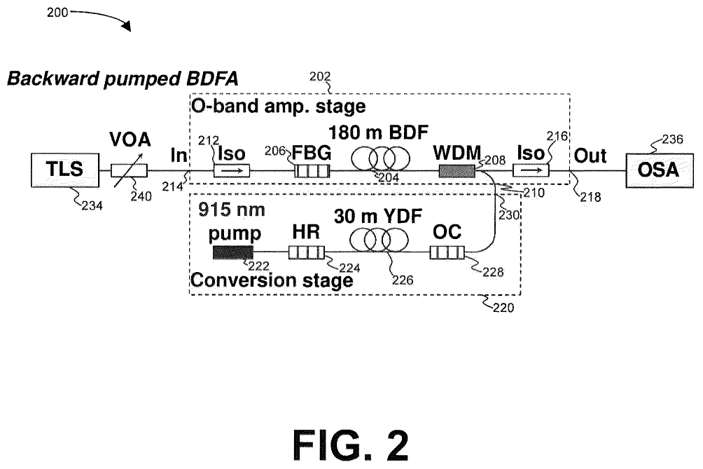

Another embodiment is a backward-pumped (or counter-pumped) BDFA configuration, which is shown in FIG. 2. Specifically, FIG. 2 is a block diagram showing one embodiment of a backward-pumped (or counter-pumped) BDFA system 200. Similar to the forward-pumped BDFA system of FIG. 1B, the backward-pumped BDFA system 200 of FIG. 2 comprises an amplification stage 202 and a conversion stage 220. For illustrative purposes, both the amplification stage 202 and the conversion stage 220 are shown for G-Band operation. However, it should be appreciated that the operating wavelength ranges and system parameters can be modified to accommodate amplification in other bands, such as, for example, the S-Band, the E-Band, or other wavelength ranges that are conducive to BDF amplification.

In the BDFA system 200 of FIG. 2, the amplification stage 202 comprises a BDF 204 with comparable properties (e.g., BDF core diameter, BDF cladding diameter, phospho-silicate glass prepared by MCVD, cutoff wavelength, NA, etc.) as the BDF 104 of FIGS. 1A and 1B, with the primary difference being that a 180 m-length BDF 204 was used in the backward-pumped BDFA system 200. Continuing, the amplification stage 202 further comprises an input FBG 206, which is optically coupled to the BDF input, and a WDM 208, which is optically coupled to the BDF output. Because the amplification stage 202 is backward pumped, the output of the WDM is coextensive with the amplification stage pump input 210. For some embodiments, the input FBG 206 has a reflectivity of ˜99.9% to prevent pump leakage, improve amplifier gain, and improve NF.

Similar to the amplification stage 102 of FIG. 2, one embodiment of the amplification stage 202 of FIG. 2 further comprises an input optical isolator 212 and an output optical isolator 216. The input optical isolator 212 resides at the amplification stage signal input 214, while the output optical isolator 216 is located at the amplification stage output 218.

The conversion stage 220, which pumps the amplification stage 202, comprises a pump LD 222, which (similar to the pump LD 122 of FIGS. 1A and 1B) is shown for illustrative purposes as a 10 W-rated MM uncooled pump LD for providing pump light at an operating center λ of ˜915 nm. The conversion stage 220 further comprises a HR FBG 224 that is optically coupled to the pump LD 222. For some embodiments, the HR FBG 224 has ˜99% reflectivity. Optically coupled to the HR FBG 224 is a gain-doped optical fiber 226, which is shown in FIG. 2 as a 30 m double-clad YDF with a ˜6 μm core diameter and a ˜125 μm cladding diameter. An output of the gain-doped fiber 226 is optically coupled an OC FBG 228. For some embodiments, the HR FBG 224 is written with 1 nm-3 dB-bandwidth, ˜99.9% reflectivity, while the OC FBG 228 is written with 1 nm-3 dB-bandwidth, ˜75% reflectivity, thereby permitting lasing of the gain-doped fiber 226. Insofar as the OC FBG 228 resides at the conversion stage output 230, the OC FBG 228 is optically coupled to the output of the WDM 208, which is located at the amplification stage pump input 210.

The backward-pumped BDFA system 202 further comprises a signal transmitter 234, which is shown in FIG. 2 as a tunable laser source (TLS), as well as a signal receiver 236, which is shown as an optical spectrum analyzer (OSA) 236. The signal transmitter 234 is optically coupled to the amplification stage signal input 214 via a VOA 240, while the signal receiver 236 is optically coupled to the amplification stage output 218 (at the output optical isolator 216). Insofar as the TLS, OSA, and VOA 240 are described in detail with reference to FIGS. 1A and 1B, only a truncated discussion of the TLS, OSA, and VOA is provided with reference to FIG. 2.

For some embodiments that demonstrate the suitability of the backward-pumped BDFA system 200 for near-real-time network data transmission, similar operating parameters as those discussed with reference to FIG. 1A were used. Specifically, the backward-pumped BDFA system 200 used a 400 Gb/s LR4 QSFP-DD pluggable module with 10 km nominal distance. The module was inserted into an ONT that generated 16×25 Gb/s 2³¹-1 PRBS data lanes. Inside the module, the lanes were converted to 4×50Gbaud/s PAM signals and encoded onto four (4) CWDM channels (˜1272 nm, ˜1292 nm, ˜1310 nm, ˜1330 nm) using external modulators. This baud rate and modulation format were chosen due to their high sensitivity to noise. At the receiver side of the QSFP-DD, WDM channels were separated by optical filters with 38 nm 3 dB bandwidth and converted back to electrical OOK signals.

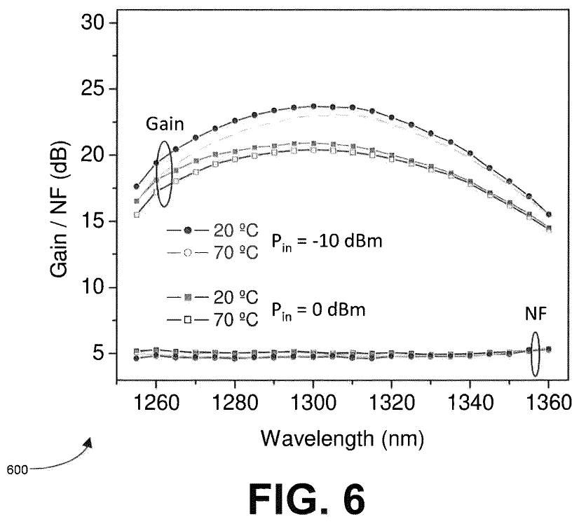

The backward-pumped BDFA system 202 demonstrated a maximum output power of 21 dBm at ˜1300 nm for an input power of 0 dBm with corresponding NF of 5.1 dB. Specific measurement data, which were gathered for the backward-pumped BDFA system 202, are shown in plot 600 in FIG. 6. Specifically, the plot 600 shows both gain and NFat operating temperatures of ˜20° C. and ˜70° C. for −10 dBm and 0 dBm input power.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. A bismuth-doped fiber amplifier (BDFA) system comprising:
an amplification stage comprising:
a fiber Bragg grating (FBG) comprising a reflectivity of approximately 99 percent (˜99%);
a wavelength division multiplexer (WDM); and
a bismuth-doped optical fiber (BDF) optically coupled between the FBG and the WDM, the BDF comprising:
a BDF core having a diameter of approximately 8 micrometers (˜8 μm);
a BDF cladding having a cladding diameter of ˜125 μm;
a numerical aperture (NA) of approximately 0.13 (˜0.13); and
a cutoff wavelength (λ) of approximately 1180 nanometers (˜1180 nm);
a conversion stage configured to pump the BDF, the conversion stage comprising:
a ten watt (10 W) rated multimode (MM) uncooled pump laser diode (LD) for providing pump light at an operating center λ of ˜915 nm, the 10 W-rated MM uncooled pump LD configured to operate at a threshold current of between approximately 510 milliamps (˜510 mA) and ˜630 mA, the 10 W-rated MM uncooled pump LD further configured to operate at a preferred operating temperature range of between approximately 20 degrees Celsius (˜20° C.) and ˜70° C., the 10 W-rated MM uncooled pump LD comprising a light-output-to-current-input-slope (LI-slope) efficiency of between ˜0.88 and ˜0.82;
a high-reflection (HR) FBG optically coupled to the 10 W-rated MM uncooled pump LD, the HR FBG comprising an ˜99% reflectivity;
a double-clad (DC) Ytterbium (Yb)-doped optical fiber (YDF) configured to convert the pump light from ˜915 nm to a center wavelength of ˜1150 nm to pump the BDF, the YDF comprising:
an ˜6 μm-diameter YDF core;
an ˜125 μm-diameter YDF inner cladding;
a YDF input optically coupled to the HR FBG; and
a YDF output; and
an output coupler (OC) FBG optically coupled to the YDF output, the OC FBG further being optically coupled to the WDM, the OC FBG comprising an ˜75% reflectivity.

2. The system of claim 1, further comprising:
a signal transmitter optically coupled to an input of the amplification stage; and
a signal receiver optically coupled to an output of the amplification stage.

3. The system of claim 2, further comprising:
a single-mode transmission fiber (SMF) optically coupled between the signal transmitter and an input to the amplification stage.

4. The system of claim 1, wherein the BDFis configured for over-pumping.

5. A forward-pumped bismuth-doped fiber amplifier (BDFA) system comprising:
an amplification stage comprising:
a bismuth-doped optical fiber (BDF) comprising:
a BDF core;
a BDF cladding;
a BDF input; and
a BDF output; and
a wavelength division multiplexer (WDM) comprising:
a WDM output optically coupled to the BDF input; and
a WDM input at an amplification stage pump input; and
a conversion stage for providing pump power to over-pump the amplification stage, the conversion stage comprising:
apump laser diode (LD);
a high-reflection (HR) fiber Bragg grating (FBG) optically coupled to the pump LD;
a gain-doped optical fiber comprising:
a gain-doped optical fiber input optically coupled to the HR FBG; and
a gain-doped optical fiber output; and
an output coupler (OC) FBG at a conversion stage output, the OC FBG being optically coupled between the gain-doped optical fiber output and the WDM input.

6. The system of claim 5, wherein the BDF is configured for over-pumping.

7. The system of claim 5, further comprising an output FBG optically coupled to the BDF output.

8. The system of claim 5, further comprising:
a signal transmitter; and
a single-mode transmission fiber (SMF) optically coupled between the signal transmitter and an input to the amplification stage.

9. The system of claim 8, further comprising a signal receiver optically coupled to an output of the amplification stage.

10. The system of claim 9, wherein the signal receiver comprises a quad small form-factor pluggable (SMFP) double-density (DD) receiver.

11. The system of claim 9, further comprising a band-pass filter (BPF) optically coupled between the output of the amplification stage and the signal receiver.

12. The system of claim 11, wherein the signal receiver comprises a quad small form-factor pluggable (SMFP) double-density (DD) receiver.

13. A backward-pumped bismuth-doped fiber amplifier (BDFA) system comprising:
an amplification stage comprising:
a bismuth-doped optical fiber (BDF) comprising:
a BDF core;
a BDF cladding;
a BDF input; and
a BDF output; and
a wavelength division multiplexer (WDM) comprising:
a WDM input optically coupled to the BDF output; and
a WDM output at an amplification stage pump input; and
a conversion stage for providing pump power to over-pump the amplification stage, the conversion stage comprising:
a pump laser diode (LD);
a high-reflection (HR) fiber Bragg grating (FBG) optically coupled to the pump LD;
a gain-doped optical fiber comprising:
a gain-doped optical fiber input optically coupled to the HR FBG; and
a gain-doped optical fiber output; and
an output coupler (OC) FBG optically coupled between the gain-doped optical fiber output and the WDM output.

14. The system of claim 13, wherein the BDF is configured for over-pumping.

15. The system of claim 14, further comprising an input FBG optically coupled to an output of the amplification stage.

16. The system of claim 13, further comprising a signal transmitter optically coupled to an input of the amplification stage.

17. The system of claim 13, further comprising:
a signal transmitter; and
a single-mode transmission fiber (SMF) optically coupled between the signal transmitter and an input to the amplification stage.
